(19) United States
(12) Patent Application Publication
(10) Pub. No.: US 2023/0316868 A1
(43) Pub. Date: Oct. 5, 2023

(54) METHOD AND SYSTEM FOR GAMING LIMIT ORDERS

(71) Applicant: Douglas DiCesare, Chicago, IL (US)

(72) Inventor: Douglas DiCesare, Chicago, IL (US)

(21) Appl. No.: 18/128,456

(22) Filed: Mar. 30, 2023

Related U.S. Application Data
(60) Provisional application No. 63/362,371, filed on Apr. 1, 2022.

(51) Int. Cl. G07F 17/32

(52) U.S. Cl. CPC G07F 17/3288

(57) ABSTRACT

A server performs automatic wager placement in response to occurrence of conditions matching a preselected multiple variable wager order for a sports event, with at least one of the variables comprising odds for the wager and at least one of the variables comprising a real-world condition relating to the sports event. A plurality of the variables may comprise real-world conditions relating to the sports event. The real-world conditions may comprise some or all of weather for the sports event, player status for the sports event, current score in the sports event, current status of play in the sports event, and/or time remaining in the sports event.

### CROSS-REFERENCE TO RELATED APPLICATION

This application claims the benefit of U.S. Provisional Patent Application No. 63/362,371, filed on Apr. 1, 2022, the disclosure of which is incorporated by reference herein.

### TECHNICAL FIELD

The present disclosure relates generally to sports gaming, and more particularly to automated use of multivariable limit orders in sports gaming.

### BACKGROUND

Sports events often generate significant interest. At times, a sports event may transcend into a moment of general cultural interest, for example as with the Super Bowl or the FIFA World Cup. At other times, sports events may be of significant interest to a substantial segment of the population, for example as may be the case with league championship events. At still other times, sports events may only be of interest to those with an interest in the outcome. The interest may be of a personal nature, with for whatever reason an individual having or feeling a personal affiliation with a particular player or team. However, a not uncommon occurrence is for the interest to be one of an economic nature, with the individual considering or having placed a wager on an outcome of or occurrence in the sports event.

A large and varied ecosystem has developed to support wagering on sports events. Much of the current infrastructure is on-line, available and used every day, 24 hours a day. An online infrastructure allows for rapid dissemination of changes in “odds” for wagers-to-be-placed, as underlying conditions for the sports event may change. The “odds” may be, for example, in the nature of a points spread, a money line, or a variety of other factors that determine whether a wager is successful, and, in some cases, a payout amount for the wager. Indeed, in many cases, wagers may be made during occurrence of a sports event itself, with the odds for the wagers-to-be-placed perhaps constantly changing.

An interested and well-informed potential wagerer may therefore wish to constantly monitor a sports event and the odds for wagers-to-be-placed, to determine a preferred time and wager conditions for placing a wager. Unfortunately, constantly monitoring a sports event may require the potential wagerer to forego other pursuits during the sports event. A wagerer may spend hours every day on their phones and computers checking on updated lines to try and beat the odds. Such constant monitoring may not be possible if the potential wagerer is considering placing wagers on an appreciable number of substantially simultaneous sporting events.

### BRIEF SUMMARY OF THE INVENTION

Some embodiments provide for automatic wager placement in response to occurrence of conditions matching a preselected multiple variable wager order for a sports event, with at least one of the variables comprising odds for the wager and at least one of the variables comprising a real-world condition relating to the sports event. In some embodiments a plurality of the variables comprise real-world conditions relating to the sports event. In some embodiments the real-world conditions comprise some or all of weather for the sports event, player status for the sports event, current score in the sports event, current status of play in the sports event, and/or time remaining in the sports event. Considering that some wager acceptance sites may not update scores, but may update odds, while others may update odds before updating scores, some embodiments allow for wagerers to more fully ensure they are making a wager they desire to make, while possibly also reducing or eliminating waste of time in checking of different sites for preferred then-current odds.

Some embodiments provide a method for use in placing a wager for a sports event, comprising: receiving, by a server, a plurality of prerequisites for placement of a wager for a sports event, the plurality of prerequisites including an odds condition for the wager and at least one real world condition relating to the sports event; receiving, by the server, information regarding changes to the odds condition and receiving information regarding changes to the at least one real world condition from at least one other server; determining, by the server, that the prerequisites of the odds condition and the at least one real world condition have been met; and in response to determining that the prerequisites of the odds condition and the at least one real world condition have been met, commanding, by the server, placement of the wager.

Some embodiments provide a system for use in placing a wager for a sports event, comprising: at least one server coupled to a network, the server including at least one processor, the at least one processor programmed by program instructions to: receive a plurality of prerequisites for placement of a wager for a sports event, the plurality of prerequisites including an odds condition for the wager and at least one real world condition relating to the sports event; receive information regarding changes to the odds condition and receiving information regarding changes to the at least one real world condition from at least one other server; determine that the prerequisites of the odds condition and the at least one real world condition have been met; and in response to determining that the prerequisites of the odds condition and the at least one real world condition have been met, command placement of the wager.

These and other aspects of the invention are more fully comprehended upon review of this disclosure.

### BRIEF DESCRIPTION OF THE DRAWINGS

FIG. 1 is a semi-block diagram of a system in accordance with aspects of the invention.

FIGS. 2A-C are tables including selectable conditions for automatic wager placement, in accordance with aspects of the invention.

FIG. 3 is a flow diagram of a process for automatic wager placement based on multiple conditions, in accordance with aspects of the invention.

FIG. 4 is a flow diagram of a further process for automatic wager placement based on multiple conditions, in accordance with aspects of the invention.

FIG. 5 is a screenshot showing slider scales useful for setting conditions for wager placement, in accordance with aspects of the invention.

FIG. 6 is a screenshot of an example display for setting conditions for placing a wager on a basketball game, in accordance with aspects of the invention.

FIGS. 7A-B illustrate a smartphone displaying further example displays for setting conditions for placing a wager, in accordance with aspects of the invention.

FIGS. 8A-B illustrate a smartphone displaying further example displays showing a change in expected likelihood of a wager being placed, in accordance with aspects of the invention.

FIG. 9 is a screenshot of an example display showing wager status for in progress sports events, in accordance with aspects of the invention.

### DETAILED DESCRIPTION

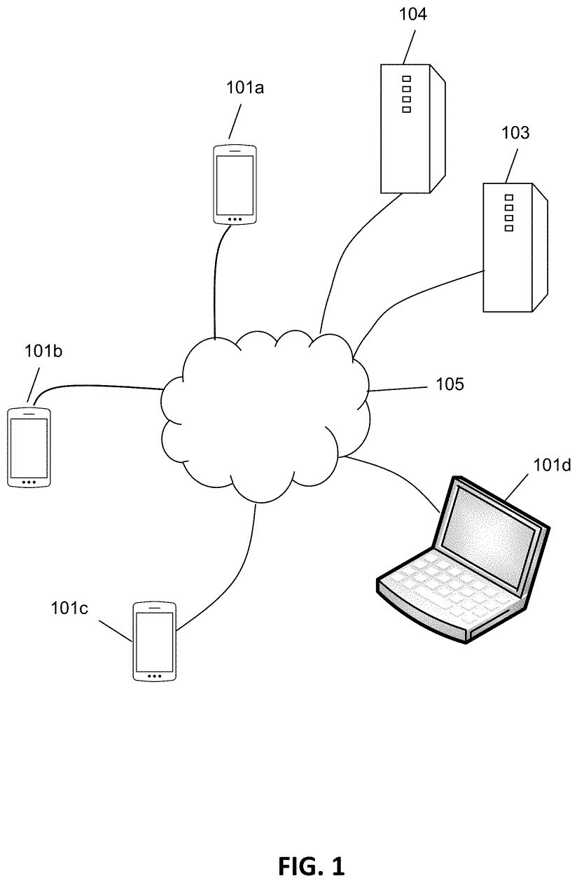

FIG. 1 is a semi-block diagram of a system in accordance with aspects of the invention. The system includes a plurality of personal compute device 101a-d coupled to a server 103 over a network 105, which may be for example the Internet. The personal compute devices may be, for example, smartphones 101a-c, a personal computer 101d (shown in the form of a laptop computer), or a variety of other computer devices, e.g., tablets, etc. In addition, for purposes of illustration, only a small number of personal compute devices are shown in FIG. 1, in some embodiments the number of personal compute devices may number in the hundreds, thousands, or hundreds of thousands.

In some embodiments the personal compute devices are configured, for example by program instructions, to allow for entry of multiple conditions for placement of a wager on a sports event. In some embodiments the personal compute devices are configured to present on a display a list of conditions that might need to be met in order for a wager on a sports event to be placed, and a selectable option for each condition to allow for selection of that condition. In some embodiments the personal compute devices may be configured to present on the display the list of conditions as a subject of the conditions and an entry field for entering a value for each condition. For example, in some embodiments a subject of a condition may be a money line for the sports event, and the entry field may be for entering a desired money line which must be met as a condition for placement of the wager. In some embodiments the entry field may allow for entry of a value by way of a pull-down menu. In some embodiments the entry field may allow for entry of a value by manipulation of a slider displayed on the display.

In some embodiments the subjects for conditions may include a money line and real-world conditions relating to the sporting event. In some embodiments the real-world conditions are physical conditions of the real-world. For example, in some embodiments the real-world conditions may be a weather condition, a number of pitches pitched by a pitcher, an injury status of a player participating in or a team member of a team participating in the sporting event, or other real-world conditions. In some embodiments the subjects for conditions may include a money line, real-world conditions of the sporting event itself, and real-world conditions of the world in which the sporting event takes place.

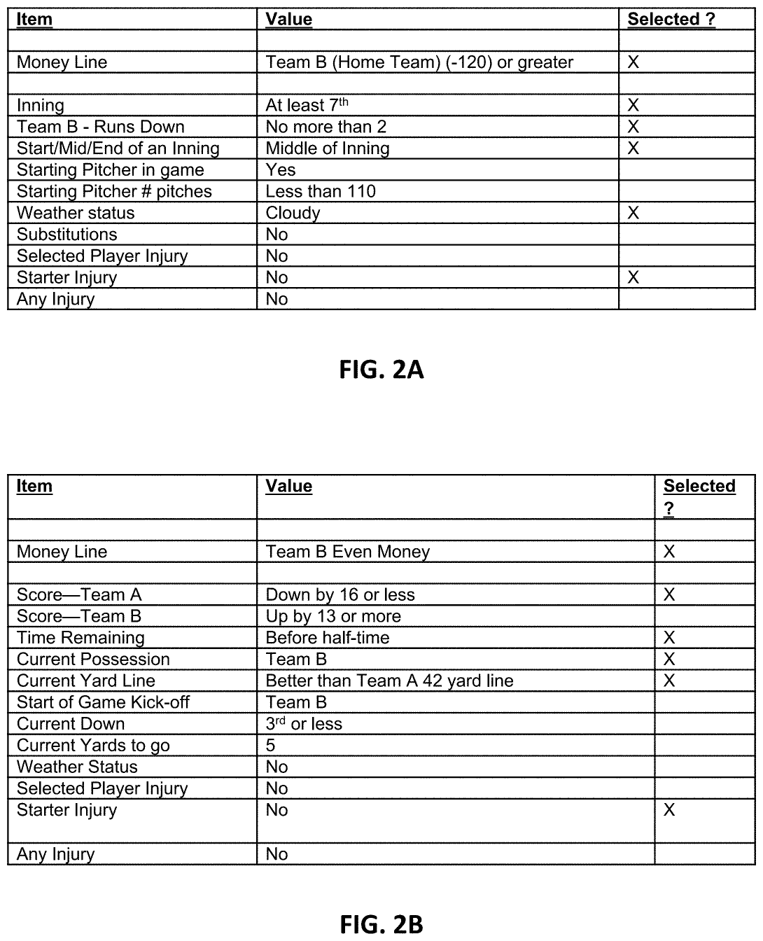

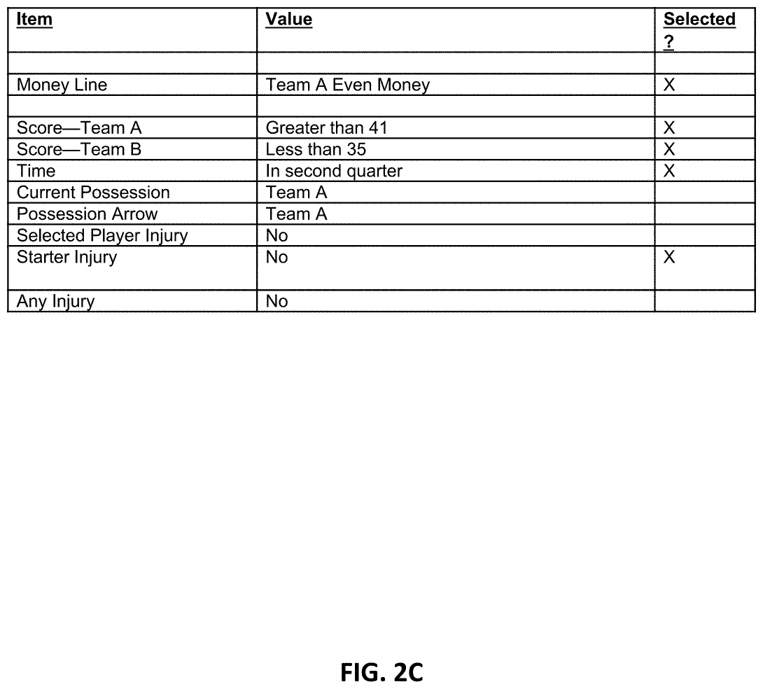

In some embodiments different sporting events may include different subjects for conditions. For example, FIG. 2A provides a table with conditions that may be applicable for a placement of wager on a baseball game. The table includes a column for subjects of conditions, a column for values for the conditions, and a column indicating whether a particular condition has been selected. The subjects for conditions in the table includes a money line and real-world conditions, including: an inning, a number of runs that one of the teams (Team B) in the game is down, whether the game is currently in-between innings, whether the starting pitcher is still in the game (for each team, in some embodiments), the number of pitches thrown by the starting pitcher (by each starting pitcher, in some embodiments), weather status, whether there have been player substitutions, whether a particular player has been injured, whether any starting players have been injured, and whether any player has been injured.

In the table of FIG. 2A, the entry field for the money line subject is Team B (−120), indicating that the money line condition is Team B, the home team, favored to win, with a $120 wager returning winnings of $100. Also in the table of FIG. 2A, the selectable option for the money line condition is shown as selected. Accordingly, the wager will not be placed if the condition has not been met, namely if the money line is other than Team B (−120). In some embodiments, however, the entry field may indicate Team B (−120 or better), indicating that the condition is that a wager on Team B to win of $120 must return winnings of at least $100.

Similarly, the entry field for the Inning subject is at least the 7th inning, indicating that inning condition is at least in the 7th inning or later of the baseball game. In the table of FIG. 2A, the selectable option for the 7th inning condition is shown as selected. Accordingly, the wager will not be placed if the condition has not been met, namely if the game is not in the 7th inning or later. The entry field for the Team B runs down condition indicates that Team B may be no more than 2 runs behind the other team. This condition is selected, so the wager will not be placed if Team B is behind more than 2 runs. The entry field for the within/between innings condition is indicating that a user may determine if the user wants a wager placed between innings (and not in the middle of a frame—a frame is the top half or bottom half of an inning). Alternatively, the condition may be change to the top half of the inning, a middle of the inning, or a bottom of the inning. In the table of FIG. 2A, the selectable option for the between innings conditions is selected. This means the wager may only be placed if the game is in the middle of an inning. The entry field for the starting pitcher indicates that the starting pitcher for Team A or Team B is still in the game. This condition, for example, may allow a user to attempt to capitalize on a pitcher's fatigue or strength depending on the wager. This entry is not selected in the table of FIG. 2A. This means the condition does not affect the wagering requirements. The entry field for the starting pitcher indicates how many pitches the starting pitcher for Team A or Team B has thrown. This condition may allow a user to estimate on average how much longer a pitcher will remain in the game. This condition, like the “starting pitcher in game” may allow a user to attempt to capitalize on a pitcher's fatigue or strength depending on the wager. The entry field for the weather status indicates if there are any unusual weather conditions. Heavy winds blowing out which could allow better ball flight, rain which may make it more difficult to grip a ball or see a pitch, snow, extreme heat causing cramping, etc. Also, in the table of FIG. 2A, the selectable option for the weather status condition, cloudy, is shown as selected, requiring that the weather at the location of the sporting event be cloudy for the wager to be placed. The entry field for substitutions indicates a condition where a starting player or pitcher was removed from the game resulting is a bench player taking their place on the live roster. In the table of FIG. 2A, the selectable option for substitution is not selected. Accordingly, the wager will still be placed regardless of how many substitutions are made by either team during the game. The entry field for selected player injury will show a list of players a user may select as a condition. If said player becomes injured, the wager is null and void. There will also be a selection in certain sports that will show “Featured” or “Starter” or “Any” Player Injuries. This can be a condition where if any “Featured” or “Starter” or “Any” from a team is injured, the wager will not be placed because the conditions are not met.

Accordingly, for the conditions of the table of FIG. 2A, a wager will be placed if all of the following is true: the money line is Team B (−120), the game is in at least the 7th inning, Team B is down by no more than 2 runs, it is the middle of the inning, the weather at the site of the game is cloudy, and no starting player is injured.

In some embodiments some of the conditions may be highlighted or otherwise marked as conditions more often selected by users. For example, in the table of FIG. 2A, the money line, inning (corresponding to time remaining), runs down (corresponding to relative score), and injury conditions may be marked as conditions more often selected by users, or, alternatively, expected to be more often selected by users.

FIG. 2B provides a table with conditions that may be applicable for a placement of wager on a football game. Like the table of FIG. 2A, the table of FIG. 2B includes a column for subjects of conditions, a column for values for the conditions, and a column indicating whether a particular condition has been selected. In the table of FIG. 2B, the entry field for the money line subject is Team B (EVEN), indicating that the money line condition is Team B wins, with a $100 wager returning winnings of $100. Also, in the table of FIG. 2A, the selectable option for the money line condition is shown as selected. Accordingly, the wager will not be placed if the condition has not been met, namely if the money line is other than Team B (EVEN). In some embodiments, however, the entry field may indicate Team B (EVEN or greater (e.g., +110, etc.), indicating that the condition is that a wager on Team B to win if $100 must return winnings of at least $100.

Also in the table of FIG. 2B, the entry field for the Team A score is Team A being down by 16 points or less. In this scenario, Team A must be down by 16 points or less. Also, in the table of FIG. 2A, the selectable option for Team A score is shown as selected. Accordingly, the wager will not be placed if the condition has not been met. Similarly, the entry field for the Team B score is Team B being up by 13 points or more. The condition for the Team B score is indicated as not selected. The entry field for the time remaining is before half time, indicating that if the football game is before halftime, this condition will be met. In the table of FIG. 2A, the selectable option for “Time remaining” condition is shown as selected. Accordingly, the wager will not be placed if the condition has not been met. In some embodiments, however, the entry field may indicate before half time. The entry field for the current possession is Team B, indicating that the current possession condition is that Team B must have the possession. Also, in the table of FIG. 2A, the selectable option for Team B condition is shown as selected. Accordingly, the wager will not be placed if the condition has not been met, namely if Team B does not have possession of the ball. The entry field for the current yard line is Better than Team A's 42-yard line, indicating that the current yard line must be less than 42 yards to the end zone for Team B. Also, in the table of FIG. 2A, the selectable option for current yard line condition is shown as selected. Accordingly, the wager will not be placed if the condition has not been met, namely if the ball is not closer to the end zone for Team B than Team A's 42-yard line. The entry field for the current down is 3rd or less, indicating that the current down for Team B must be 3rd down, 2nd down, or 1st down. Also, in the table of FIG. 2A, the selectable option for current down is not selected. This means the condition does not affect the wagering requirements. The entry field for the Weather status indicates if there are any unusual weather conditions. Heavy winds blowing out which could allow better ball flight, rain which may make it more difficult to grip a ball or enhance your chances to lose a fumble, snow, extreme heat causing cramping, etc. Also, in the table of FIG. 2B, the Weather status is not selected. The entry field for selected player injury will show a list of players a wagerer can select as a condition. If said player becomes injured, the wager is not placed. There will also be a selection in certain sports that will show “Featured” or “Starter” or “Any” Player Injuries. This can be a condition where if any “Featured” or “Starter” or “Any” from a team is injured, the wager will not be placed because the conditions are not met. In FIG. 2B, the starter injury condition is shown as selected, meaning that the wager will not be placed if any starting player for a team engaged in the sporting event is injured.

Accordingly, for the conditions of the table of FIG. 2B, a wager will be placed if all of the following is true: the money line is Team B even money, Team A is down by 16 points or less, the game is before half-time, Team B has the ball at better than the 42 yard line of Team A, and no starting player is injured.

As with the table of FIG. 2A, in the table of FIG. 2B some of the conditions may be highlighted or otherwise marked as conditions more often selected by users. For example, in the table of FIG. 2B, the money line, time remaining, one of the score conditions, current possession, and injury conditions may be marked as conditions more often selected by users, or, alternatively, expected to be more often selected by users.

FIG. 2C provides a table with conditions that may be applicable for a placement of wager on a basketball game. Like the tables of FIGS. 2A and 2B, the table of FIG. 2C includes a column for subjects of conditions, a column for values for the conditions, and a column indicating whether a particular condition has been selected. In the table of FIG. 2C, the entry field for the money line subject is Team A (EVEN), indicating that the money line condition is Team A wins, with a $100 wager returning winnings of $100. Also, in the table of FIG. 2C, the selectable option for the money line condition is shown as selected. Accordingly, the wager will not be placed if the condition has not been met, namely if the money line is other than Team A (EVEN). In some embodiments, however, the entry field may indicate Team A EVEN or greater (e.g., +110, etc.), indicating that the condition is that a wager on Team B to win if $100 must return winnings of at least $100.

Also in the table of FIG. 2C, the entry field for the money line subject is Team A having more than 41 points, while Team B has less than 35 points. Also, in the table of FIG. 2C, the selectable option for Score-Team A and Score Team B are both shown as selected. Accordingly, the wager will not be placed if both of the conditions have not been met. The time entry field is in the second quarter, and the selectable option for “Time remaining” condition is shown as selected. Accordingly, the wager will not be placed if the condition has not been met. In some embodiments, however, the entry field may indicate some other value, such as before half time, or before or after some specific time in a specific quarter or half. The entry field for the current possession is Team A, indicating that the current possession condition is that Team A must have the possession. In the table of FIG. 2C, the selectable option for current possession is not selected. This means the condition does not affect the wagering conditions. The entry field for possession arrow is Team A, indicating that the current possession arrow is that Team A must have the possession arrow. In the table of FIG. 2C, the selectable option for possession arrow is not selected. This means the condition does not affect the wagering conditions. The entry field for selected player injury will show a list of players a wagerer can select as a condition. If said player becomes injured, the wager is null and void. There will also be a selection in certain sports that will show “Featured” or “Starter” or “Any” Player Injuries. This can be a condition where if any “Featured” or “Starter” or “Any” from a team is injured, the wager will not be placed because the conditions are not met. In the table of FIG. 2C, the no starter injury has been selected, meaning that no wager will be placed if any starter from either team is injured.

Accordingly, for the conditions of the table of FIG. 2C, a wager will be placed if all of the following is true: the money line is Team A even money, Team A has scored more than 41 points, Team B has scored less than 35 points, the game is in the second quarter, and no starting player is injured.

As with the tables of FIG. 2A and FIG. 2B, in the table of FIG. 2C some of the conditions may be highlighted or otherwise marked as conditions more often selected by users. For example, in the table of FIG. 2C, the money line, score, time remaining, and injury conditions may be marked as conditions more often selected by users, or, alternatively, expected to be more often selected by users.

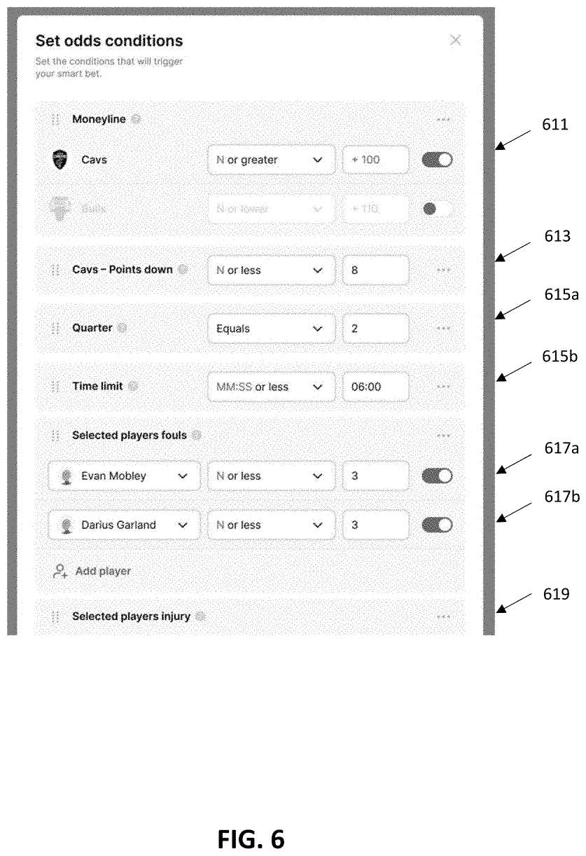

FIG. 6 is a screenshot of an example display for setting conditions for placing a wager on a basketball game. The display includes a plurality of fields for setting the conditions. The fields may include drop-down menus and/or fields for user data entry. The screenshot may be displayed, for example, on a compute device of a user. The compute device may be a smartphone.

The display includes moneyline condition fields 611. The moneyline condition fields allow for setting of the moneyline with respect to a selected one of either of the two basketball teams engaged in the sporting event, and a required line for the selected team.

The display also includes real world conditions fields. In the example of FIG. 6, all of the real world conditions relate to events of the sporting event. In FIG. 6, the real world conditions include a score related field 613, event time related fields 615a,b, and player fouls related fields 617a,b. For each of the fields, selections may be made using drop down menus, with details of the selection enterable into data entry fields using data input devices of the compute device. The score related field indicates the selected team must be down by less than 8 points. The time related fields, of which there are two, indicate that the sporting event must be in the second quarter, with six minutes or less remaining in the second quarter. The player fouls related fields indicates that a first selected player must have less than three fouls, and a second selected player must have less than three fouls. The selected players may be selected from drop down menus, for example, and as indicated in the embodiment of FIG. 6.

In some embodiments a display of the user compute device may provide additional information regarding the conditions. For example, in some embodiments condition subjects commonly selected by other users may be so indicated, for example by a star, an asterisk, highlighting, or some other notation. Also for example, in some embodiments a percentage of times each condition subject has been selected by users in the past may be presented in a further column.

In some embodiments the personal compute devices provide the conditions to the server, along with an amount to wager if, and only if, the conditions are met, and in some cases along with an identification of a source of funds for the wager.

The server is configured to receive the conditions and the amount to wager, determine if the wager should be placed, and place the wager in response to determining that the wager should be placed. In some embodiments the server stores an identifier of a wagerer and information regarding each potential wager, for example the conditions for each potential wager and an amount for each potential wager, in a database or other data structure. The server is also configured to receive information regarding events and status of sporting events, and events and status regarding real-world conditions. In some embodiments the server receives the information from information aggregator servers. In some embodiments the server receives the information in response to requests made to other servers for the information. In some embodiments the server receives the information from compute devices operated by individuals monitoring the sporting events or other conditions.

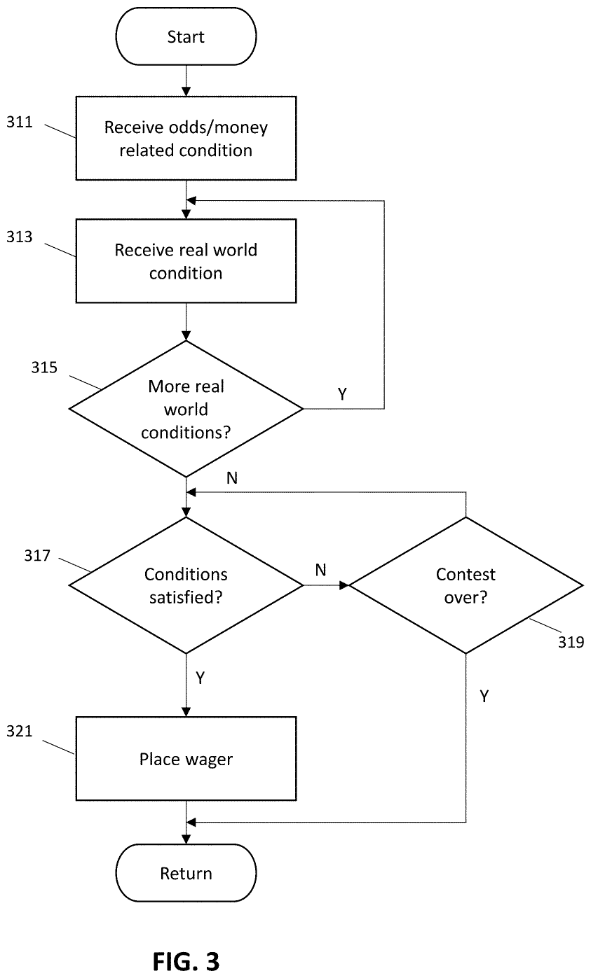

FIG. 3 is a flow diagram of a process for automatic wager placement based on multiple conditions, in accordance with aspects of the invention. In some embodiments the process is performed by the system of FIG. 1. In some embodiments the process is performed by the server of FIG. 1. In some embodiments the process is performed by a server. In some embodiments the process is performed by one or more processors configured by program instructions.

In block 311, the process receives an odds or money line related condition for placement of a wager. In some embodiments the odds or money line related condition is provided by a user compute device. In some embodiments the odds or money line related condition specifies a specific odds or money line condition for placement of the wager. In some embodiments the odds or money line related condition specifies a minimum or maximum odds or money line condition to be satisfied for placement of the wager. In some embodiments the process also receives information of a wager to-be-placed, with the information of the wager to-be-placed for example indicating an amount to be wagered and a side (which team, player, or outcome) on which the wager is to be placed. In some embodiments the information of the wager to-be-placed is provided with or immediately after receipt of the conditions under which the wager is to be placed. In some embodiments the information of the wager to-be-placed is provided using a separate process.

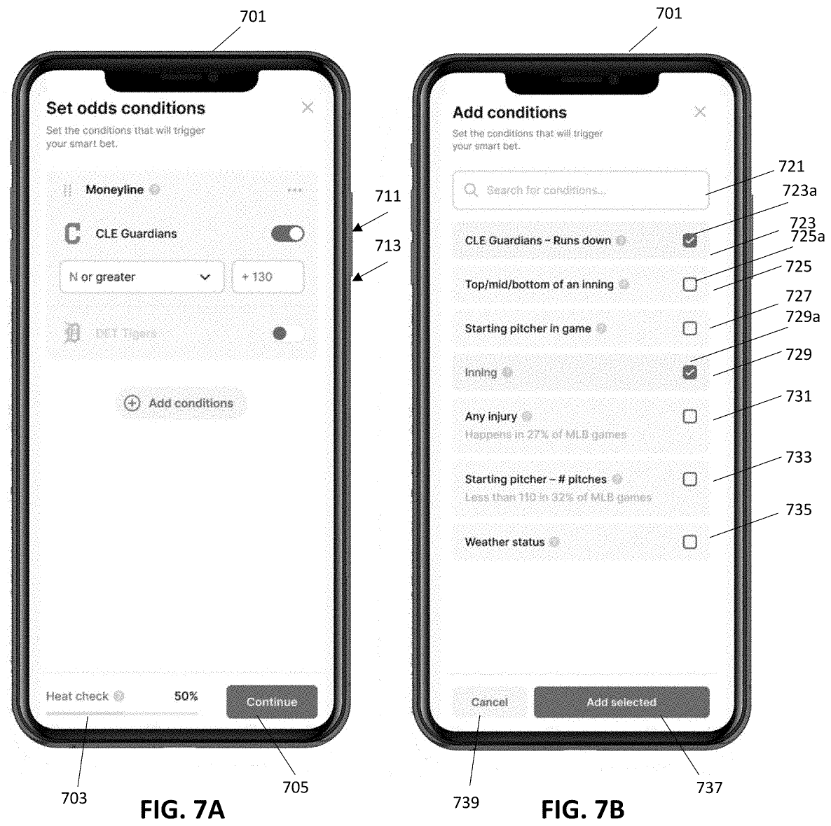

For example, FIG. 7A illustrates a smartphone 701 displaying an example display for setting a moneyline condition for placing a wager. In some embodiments setting of a moneyline condition for placing a wager is performed prior to setting other conditions for placing a wager. In FIG. 7A, the moneyline is for a baseball game, and a user is provided with a team option 711 to select either team, with a first team selected. The user is also provided condition fields 713 including a drop down menu to select an option with respect to the moneyline, and a data entry field to enter a value for the money line.

The display of FIG. 7A also includes a “heat check” value 703. The heat check value is, in some embodiments, an estimate of the likelihood of the conditions being met for placement of the wager. In some embodiments the estimate is based on historical data for sporting events generally, in some embodiments the estimate is based on historical data for the type of sporting event at issue, and in some embodiments the estimate is based on historical data for sporting events between the teams (or individuals) engaged in the sporting event. Upon setting of the moneyline condition, the user may select a continue button 705, and continue to display of displays for setting real-world conditions for placement of the wager.

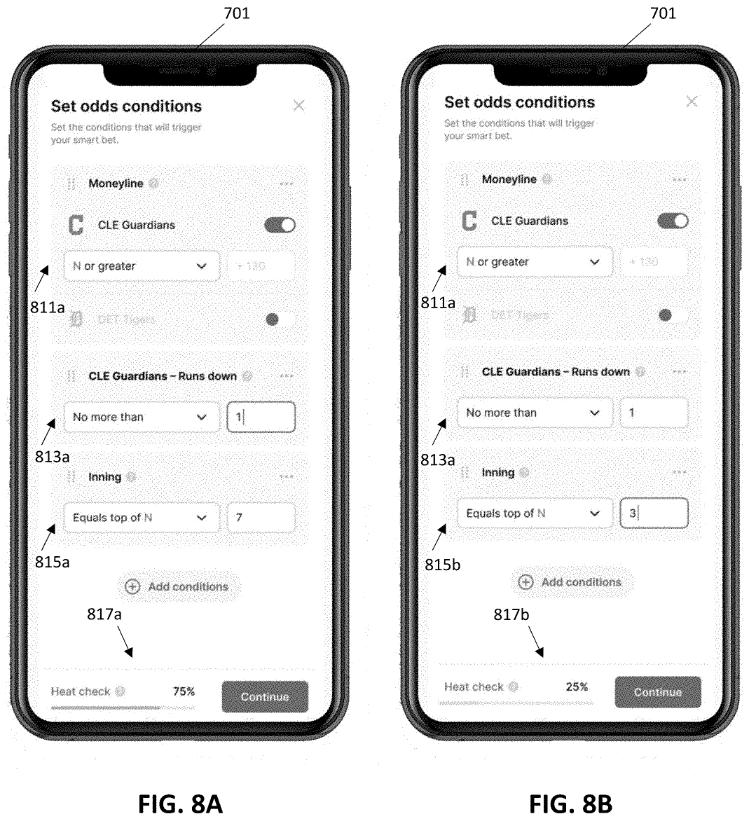

FIGS. 8A-B further illustrate operation of the heat check value. FIG. 8A illustrates a smartphone 701 displaying an example display in which a moneyline condition 811a, a scoring condition 813a, and an inning condition 815a have been selected for a baseball game. The moneyline condition is a first selected team is +130, the scoring condition is that the selected team is no more than one run down, and the inning condition is that the inning is the top of the seventh inning. In these circumstances, as an example value only, a heat check value 817a indicates a 75% expectation that the conditions will be met. FIG. 8B illustrates the smartphone displaying the example display, with one modification to the conditions. In FIG. 8B, the inning condition has been changed to the top of the third inning. With this change, the example heat check value has changed to 25%, indicating, perhaps anomalously, that there is only a 25% expectation that the condition will be met.

In block 313 the process receives a real-world condition for placement of the wager. In some embodiments the real-world condition is provided by a user compute device. In some embodiments the real-world condition is a physical condition of the real-world.

FIG. 7B illustrates the smartphone 701 displaying an example display for setting real-world conditions for placement of the wager for a baseball game. The real-world conditions include several real-world conditions for events of the sporting event, and a single real-world condition for the location of the sporting event. The display includes a search field 721. The search field allows for a search of real-world conditions based on data entered in the search field. The display also includes selections for a score condition 723, a part of inning condition 725, a starting pitcher status condition 727, an inning condition 729, an injury condition 731, a number of pitches by starting pitcher condition 733, and a weather condition 735 at the site of the sporting event. For each of the conditions, a box may be checked to have the condition selected. For example, a score condition box 723a and an inning condition box 729a are checked, while a part of inning condition box 725a is not checked. The display also includes an add selected button 737 and a cancel button 739.

In block 315 the process determines if there are more real-world conditions to receive. If so, the process returns to operations of block 313. Otherwise, the process continues to block 317. In block 317 the process determines if the conditions have been satisfied. In some embodiments the process receives information regarding the conditions from one or more other servers, and uses that information in determining if the conditions have been satisfied. In some embodiments a server performing the process sets one or some of the information regarding the conditions, for example the money line/odds for the sporting event, and receives information regarding others of the conditions form other servers. In some embodiments the process determines if the conditions have been satisfied whenever a change in information regarding any of the conditions occurs.

If the conditions have not been satisfied, the process determines if the contest is over in block 319. If so, the process returns. Otherwise the process continues the operations of block 317 to determine if the conditions have been satisfied. If the process determines that the conditions have been satisfied, and in some embodiments in response to determining that the conditions have been satisfied, the process continues to block 321.

In block 321 the process places a wager on the sporting event. In some embodiments the wager is in accordance with the information of the wager to-be-placed discussed above.

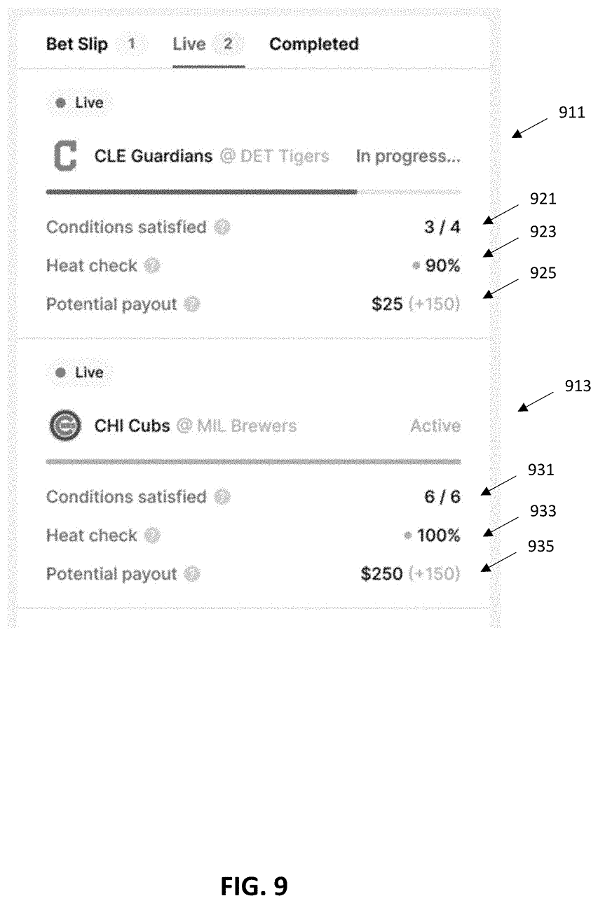

In some embodiments the process provides status of wagers for in progress sports events. In some embodiments the server provides information as to status of the wagers to a user compute device, for example a user smartphone. FIG. 9 is a screenshot of an example display showing wager status for in progress sports events. The display may be shown, for example, on a user smartphone. The example display shows status of wagers for two in progress sports events. A first sports event 911 is shown as in progress. A conditions satisfied indicator 921 for the first sports event shows that three out of four conditions have been satisfied. A heat check indicator 923 for the first sports event indicates a 90% likelihood that all of the conditions will be satisfied and a wager placed on the first sports event. A potential payout indicator 925 for the first sports event also indicates a potential payout if the wager is placed and is a winning wager. Similarly, a second sports event 913 is also shown as in progress. A conditions satisfied indicator 931 for the second sports event shows that all six out of six conditions have been satisfied. A heat check indicator 933 for the second sports event indicates a 100% likelihood that all of the conditions will be satisfied, as they have all been satisfied, with a wager therefore placed on the second sports event. A potential payout indicator 925 for the second sports event also indicates a potential payout if the wager is placed and is a winning wager.

The process thereafter returns.

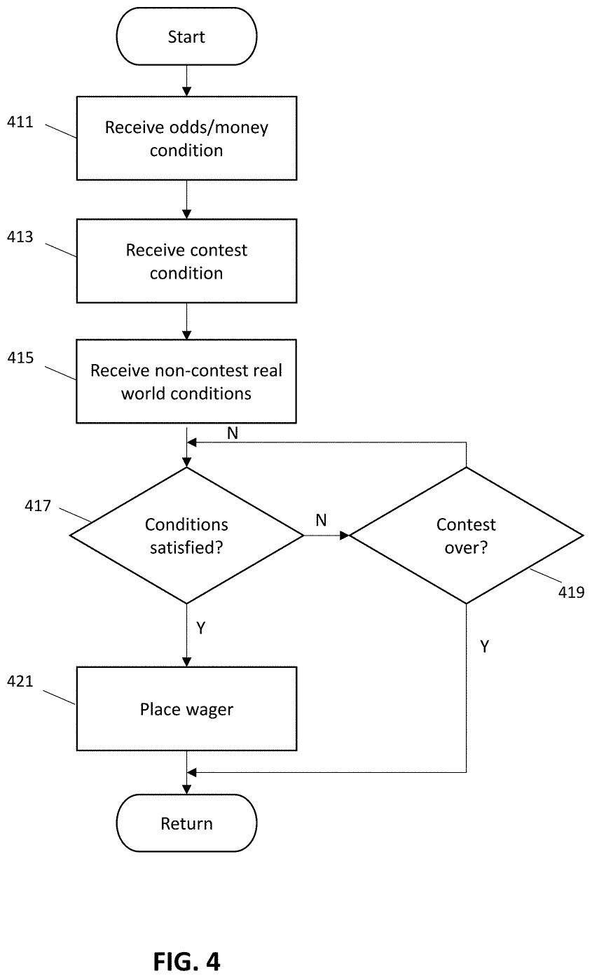

FIG. 4 is a flow diagram of a process for automatic wager placement based on multiple conditions, in accordance with aspects of the invention. In some embodiments the process is performed by the system of FIG. 1. In some embodiments the process is performed by the server of FIG. 1. In some embodiments the process is performed by a server. In some embodiments the process is performed by one or more processors configured by program instructions.

In block 411, the process receives an odds or money line related condition for placement of a wager. In some embodiments the odds or money line related condition is provided by a user compute device. In some embodiments the odds or money line related condition specifies a specific odds or money line condition for placement of the wager. In some embodiments the odds or money line related condition specifies a minimum or maximum odds or money line condition to be satisfied for placement of the wager. In some embodiments the process also receives information of a wager to-be-placed, with the information of the wager to-be-placed for example indicating an amount to be wagered and a side (which team, player, or outcome) on which the wager is to be placed. In some embodiments the information of the wager to-be-placed is provided with or immediately after receipt of the conditions under which the wager is to be placed. In some embodiments the information of the wager to-be-placed is provided using a separate process.

In block 413 the process receives conditions for the sporting event itself. In some embodiments the process receives the conditions for the sporting event itself from a user compute device. The conditions for the sporting event itself are conditions that may be satisfied by a state of the sporting event and/or players in or on a team participating in the sporting event. The state of the sporting event and/or players may include, for example, an amount of time or innings played or left in the sporting event, a number of pitches by a starting pitcher or a number of completions by a quarterback in the sporting event, a number of three point plays or goals scored by a particular player on one of the teams engaged in the sporting event, whether a particular player on a particular one of the teams in the sporting event is injured, etc.

In block 415 the process receives real-world conditions for other than the sporting event itself. In some embodiments the process receives the real-world conditions for other than the sporting event itself from a user compute device. The real-world conditions for other than the sporting event itself may be, for example, a temperature at a location of the sporting event, a time of day at the location of the sporting event, some other condition or state at the location of the sporting event, or even some location other than the location of the sporting event, even locations hundreds or thousands of miles away from the location of the sporting event.

In block 417 the process determines if the conditions have been satisfied. In some embodiments the process receives information regarding the conditions from one or more other servers, and uses that information in determining if the conditions have been satisfied. In some embodiments a server performing the process sets one or some of the information regarding the conditions, for example the money line/odds for the sporting event, and receives information regarding others of the conditions form other servers. In some embodiments the process determines if the conditions have been satisfied whenever a change in information regarding any of the conditions occurs.

If the conditions have not been satisfied, the process determines if the contest is over in block 419. If so, the process returns. Otherwise the process continues the operations of block 417 to determine if the conditions have been satisfied. If the process determines that the conditions have been satisfied, and in some embodiments in response to determining that the conditions have been satisfied, the process continues to block 421.

In block 421 the process places a wager on the sporting event. In some embodiments the wager is in accordance with the information of the wager to-be-placed discussed above.

The process thereafter returns.

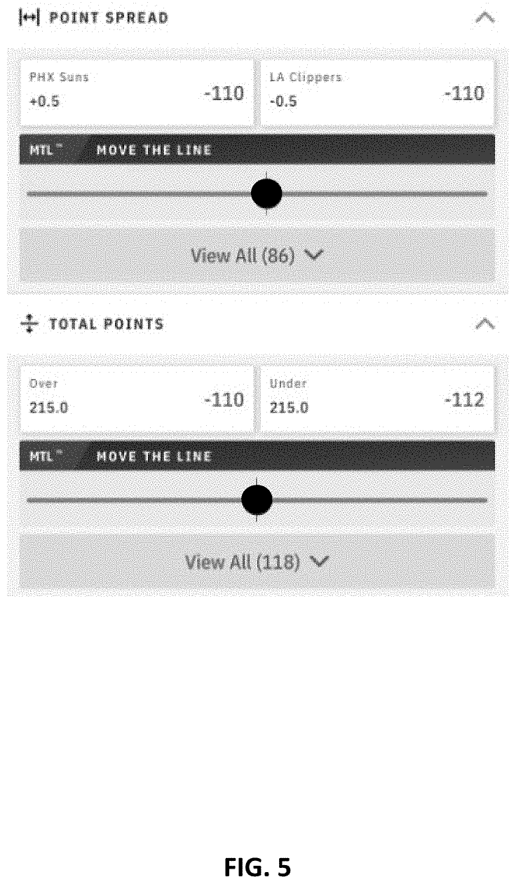

FIG. 5 is a screenshot showing slider scales useful for setting conditions for wager placement. The screen shot may be of a display of a user compute device. The screenshot of FIG. 5 includes two slider bars. A first slider may be used to adjust a point spread value (for a money line condition) for a basketball game. In some embodiments the first slider may be used in selecting a money line/odds condition for a sporting event. A second slider may be used to adjust a total points value for a money line condition for the basketball. Additional sliders may be used for adjusting various of the other conditions for placement of a wager, instead of, in addition to, or complementing use of the example tables in FIGS. 2A-2C.

Although the invention has been discussed with respect to various embodiments, it should be recognized that the invention comprises the novel and non-obvious claims supported by this disclosure.

What is claimed is:

1. A method for use in placing a wager for a sports event, comprising:
receiving, by a server, a plurality of prerequisites for placement of a wager for a sports event, the plurality of prerequisites including an odds condition for the wager and at least one real world condition relating to the sports event;
receiving, by the server, information regarding changes to the odds condition and receiving information regarding changes to the at least one real world condition from at least one other server;
determining, by the server, that the prerequisites of the odds condition and the at least one real world condition have been met; and
in response to determining that the prerequisites of the odds condition and the at least one real world condition have been met, commanding, by the server, placement of the wager.

2. The method of claim 1, wherein commanding placement of the wager comprises placing the wager.

3. The method of claim 1, wherein the wager is placed on another server.

4. The method of claim 1, wherein the wager is placed on the server.

5. The method of claim 1, wherein the at least one real world condition comprises real world conditions at a location of the sports event.

6. The method of claim 1, wherein the real world conditions at the location of the sports event comprise weather conditions at the location of the sports event.

7. The method of claim 1, wherein the at least one real world condition comprises real world conditions concerning a state of the sporting event and/or players participating in the sporting event.

8. The method of claim 7, wherein the at least one real world condition comprises a plurality of real world conditions.

9. The method of claim 8, further comprising providing, by the server and over a network, a plurality of selectable options for selecting the real world conditions.

10. The method of claim 7, wherein the real world conditions are selectable from a predetermined list of real world conditions.

11. The method of claim 10, wherein the sporting event may be one of several types of sporting events.

12. The method of claim 11, wherein the predetermined list of real world conditions is different for different types of sporting events.

13. The method of claim 1, wherein odds condition and the at least one real world condition are received by the server from a compute device of a user.

14. A system for use in placing a wager for a sports event, comprising:
at least one server coupled to a network, the server including at least one processor, the at least one processor programmed by program instructions to:
receive a plurality of prerequisites for placement of a wager for a sports event, the plurality of prerequisites including an odds condition for the wager and at least one real world condition relating to the sports event;
receive information regarding changes to the odds condition and receiving information regarding changes to the at least one real world condition from at least one other server;
determine that the prerequisites of the odds condition and the at least one real world condition have been met; and
in response to determining that the prerequisites of the odds condition and the at least one real world condition have been met, command placement of the wager.

15. The system of claim 14, further comprising user compute device coupled to the network, the user compute device configured to receive user inputs of the odds condition and the at least one real world condition, and to provide the server the odds condition and the at least one real world condition.

16. The system of claim 14, wherein the at least one processor is configured by program instructions to command placement of the wager by transmitting a request for the wager to another server.

17. The system of claim 14, wherein the at least one real world condition comprises real world conditions concerning a state of the sporting event and/or players participating in the sporting event.

18. The system of claim 14, wherein the at least one real world condition comprises real world conditions at a location of the sports event.
